(19) United States
(12) Patent Application Publication
(10) Pub. No.: US 2024/0403242 A1
(43) Pub. Date: Dec. 5, 2024

(54) DYNAMIC REALLOCATION OF DISPLAY MEMORY BANDWIDTH BASED ON SYSTEM STATE

(71) Applicants: Advanced Micro Devices, Inc., Santa Clara, CA (US); ATI Technologies ULC, Markham (CA)

(72) Inventors: Ashish Jain, Austin, TX (US); Gia Tung Phan, Markham (CA); Shang Yang, Markham (CA)

(21) Appl. No.: 18/327,813

(22) Filed: Jun. 1, 2023

(51) Int. Cl. G06F 13/16; G06F 13/18

(52) U.S. Cl. CPC G06F 13/1678; G06F 13/1663; G06F 13/18

(57) ABSTRACT

An apparatus and method for efficiently managing memory bandwidth within a communication fabric. A computing system includes multiple clients, a display controller, and a communication fabric that transfers data between the multiple clients, the display controller, and a memory subsystem. A control circuit with power management circuitry determines that one or more conditions are satisfied for changing a power-performance state (P-state) of the memory subsystem. The control circuit asserts indications on a sideband interface specifying to the communication fabric that the display controller is to have an increased bandwidth of data transfer between the display controller and the memory subsystem. Using the increased bandwidth provided by the communication fabric, the display controller prefetches display data from a frame buffer of the memory subsystem prior to the P-state change. Afterward, the memory subsystem performs the P-state change and the corresponding training of the memory interface.

### BACKGROUND

### Description of the Relevant Art

Both planar transistors (devices) and non-planar transistors are fabricated for use in integrated circuits within semiconductor chips. A variety of choices exist for placing processing circuitry in system packaging to integrate multiple types of integrated circuits. Some examples are a system-on-a-chip (SOC), multi-chip modules (MCMs) and a system-in-package (SiP). Mobile devices, desktop systems, and servers use these packages. Regardless of the choice for system packaging, in several uses, it is beneficial for the operating parameters of the memory subsystem to change based on conditions of the computing system. However, adjusting these operating parameters causes required training of the memory interface. The operating parameters include one or more of the operating clock frequency and the operating power supply voltage level of one or more memory devices of the memory subsystem. During the steps of this training, a memory blackout period (i.e., the period during which memory accesses are not permitted) occurs. Accordingly, visual artifacts due to interrupts or delays in the display data arriving at a display controller from the memory subsystem occurs. If the adjustments of the operating parameters are skipped to avoid the visual artifacts, then the memory subsystem does not operate in an optimal manner regarding performance or power consumption.

In view of the above, methods and mechanisms for efficiently managing memory bandwidth within a communication fabric are desired.

### BRIEF DESCRIPTION OF THE DRAWINGS

FIG. 1 is a generalized block diagram of a computing system that manages memory bandwidth within a communication fabric.

FIG. 2 is a generalized block diagram of a fabric switch that manages memory bandwidth within a communication fabric.

FIG. 3 is a generalized block diagram of signal waveforms illustrating timing of a memory clock frequency update and prefetch of display data in a computing system.

FIG. 4 is a generalized block diagram of a method for performing a prefetch of display data in advance of a performance-state change of a memory storing display data.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Systems, apparatuses, and methods for efficiently managing memory bandwidth within a communication fabric are disclosed. A computing system includes multiple clients and a display controller that generate memory access requests targeting data stored in a memory subsystem. Examples of the clients are a variety of types of processors, one of a variety of input/output (I/O) peripheral devices, and so forth. The computing system also includes a communication fabric that transfers data between the multiple clients, the display controller, and the memory subsystem. A control circuit with power management circuitry determines that one or more conditions are satisfied for changing a power-performance state (P-state) of the memory subsystem. In an implementation, the control circuit has detected an increase or decrease in required memory bandwidth based on applications being executed (or tasks queued during execution of the applications), thermal conditions, or otherwise.

The control circuit asserts one or more indications on a sideband interface specifying to the communication fabric that the display controller is to have an increased bandwidth (or rate) of data transfer between the display controller and the memory subsystem. In other words, the indication causes an increase in memory bandwidth, of the memory subsystem, allocated to the display controller. Prior to the P-state change of the memory subsystem, using the increased bandwidth provided by the communication fabric, the display controller prefetches display data from a frame buffer of the memory subsystem. This prefetched display data is not immediately sent to the display device. The prefetching of this display data is performed in addition to the fetching of display data that is immediately sent to the display device. Therefore, the display controller requires the increased bandwidth of data transfer between the display controller and the memory subsystem. The display controller requires the prefetched data to later send to the display device during the training of the memory interface that occurs as a result of the upcoming P-state change of the memory subsystem. Therefore, during training of the memory interface performed in preparation for the upcoming P-state change, the display device continues to receive display data and avoids visual artifacts due to interrupts or delays in the display data arriving at a display controller from the memory subsystem.

In some implementations, the control circuit also reduces the bandwidth of data transfer between the memory subsystem and one or more clients different from the display controller. Examples of the clients are a variety of types of processors, one or more of a variety of input/output (I/O) peripheral devices, and so forth. The duration of the bandwidth adjustment in the communication fabric for the one or more clients and the display controller varies depending on the implementation. After the memory subsystem performs the P-state change and the corresponding training of the memory interface, the control circuit performs bandwidth adjustments in the communication fabric to return the bandwidth allocations to original values for one or more sources generating memory access requests. The sources include the one or more clients and the display controller. Therefore, when there is no P-state change for the memory subsystem, the control circuit can assign high memory bandwidth allocations to one or more clients for processing workloads. When there is a P-state change for the memory subsystem, the control circuit can adjust the memory bandwidth allocations of the one or more clients and the display controller to support prefetching of display data.

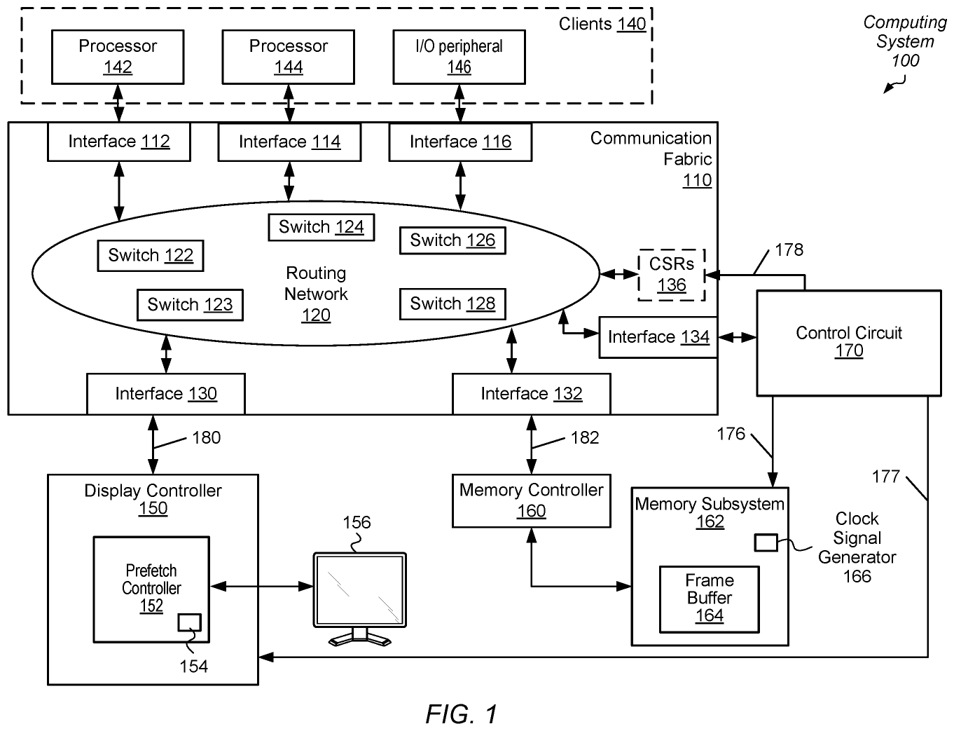

Turning now to FIG. 1, a generalized block diagram of one implementation of a computing system 100 is shown. As shown, the computing system 100 includes communication fabric 110 between the computing clients 140, the display controller 150, the memory controller 160, and the control circuit 170. Memory controller 160 is used for interfacing with memory subsystem 162. The computing clients 140 (or clients 140) include the processor 142, the processor 144, and the input/output (I/O) interface 146. Although three clients are shown, in other implementations, computing system 100 includes any number of clients and other types of clients, such as a network interface and so forth. In other implementations, computing system 100 includes other components and/or computing system 100 is arranged differently. In some implementations, the computing system 100 is a system on a chip (SoC) with each of the depicted components integrated on a single semiconductor die. In other implementations, the components are individual dies in a system-in-package (SiP) or a multi-chip module (MCM).

The I/O interface 146 is representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Any network interface among the clients 140 is able to receive and send network messages across a network.

The processors 142 and 144 are representative of any number of processors which are included in the computing system 100. In one implementation, the processor 142 is a general-purpose processor, such as a central processing unit (CPU). In this implementation, the processor 142 performs steps of a graphics driver algorithm communicating with and/or controlling the operation of one or more of the other processors of the clients 140. In one implementation, the processor 144 is a data parallel processor with a highly parallel data microarchitecture. Data parallel processors include graphics processing circuits (GPUs), digital signal processors (DSPs), field programmable gate arrays (FPGAs), application specific integrated circuits (ASICs), and so forth. In some implementations, the clients 140 include multiple data parallel processors.

In one implementation, the processor 144 is a GPU which renders pixel data into frame buffer 164 representing an image. This pixel data is then provided to display controller 150 to be driven to display 156. This pixel data is written to frame buffer 164 in the memory subsystem 162 by the processor 144 and then driven to the display device 156 (or display 156) from the frame buffer 164 via the fabric 110. The pixel data stored in the frame buffer 164 represents frames of a video sequence in one implementation. In another implementation, the pixel data stored in frame buffer 164 represent the screen content of a laptop or desktop personal computer (PC). In a further implementation, the pixel data stored in frame buffer 164 represents the screen content of a mobile device (e.g., smartphone, tablet).

Although a single memory controller is shown, in other implementations, computing system 100 includes another number of memory controllers communicating with multiple memory devices. Memory controller 160 is representative of any type of memory controller accessible by the clients 140, and includes queues for storing memory access requests and memory access responses, and circuitry for supporting a communication protocol with the memory subsystem 162. Memory controller 160 communicates with any number and type of memory devices of the memory subsystem 162 such as Dynamic Random Access Memory (DRAM), Static Random Access Memory (SRAM), Graphics Double Data Rate (GDDR) Synchronous DRAM (SDRAM), NAND Flash memory, NOR flash memory, Ferroelectric Random Access Memory (FeRAM), or others. In one implementation, the interface 132 and the memory controller 160 transfer data with one another via the communication channel 182, and support one of a variety of types of the Graphics Double Data Rate (GDDR) communication protocol. In some implementations, the memory devices of the memory subsystem 162 store data in traditional DRAM or in multiple three-dimensional (3D) memory dies stacked on one another.

Display controller 150 is representative of any number of display controllers which are included in the computing system 100, with the number varying according to the implementation. Generally speaking, display controller 150 receives video image and frame data from various sources, processes the data, and then sends the data out in a format that is compatible with a target display. Display controller 150 is configured to drive a corresponding display 156 that is representative of any number of video display devices. In some implementations, a single display controller drives multiple displays. As shown in the example, display controller 150 includes buffer 154 for storing frame data to be displayed.

While prefetch controller 152 is shown as being included in display controller 150, this does not preclude prefetch controller 152 from being integrated within the display devices 156. In other words, prefetch controller 152 can be located internally or externally to the display device 156, depending on the implementation. In any implementation, whether located internally or externally to the display device 156, the prefetch controller 152 retrieves display data from the frame buffer 164 and provides this display data to the buffer 154 of the display controller 150. Therefore, the display controller 150 has display data to use for a later memory blackout period (i.e., the period during which memory accesses are not permitted) that occurs during the steps of memory training. Similarly, while buffer 154 is shown as being located within prefetch controller 152, this does not preclude buffer 154 from being located externally to prefetch controller 152 in other implementations.

The clients 140 are capable of generating on-chip network data. Examples of network data include memory access requests, memory access responses, and other network messages between the clients 140. To efficiently route data, in various implementations, communication fabric 110 uses a routing network 120 that includes network switches 122-128. In some implementations, network switches 122-128 are network on chip (NoC) switches. In an implementation, routing network 120 uses multiple network switches 122-128 in a point-to-point (P2P) ring topology. In other implementations, routing network 120 uses network switches 122-128 with programmable routing tables in a mesh topology. In yet other implementations, routing network 120 uses network switches 122-128 in a combination of topologies. In some implementations, routing network 120 includes one or more buses to reduce the number of wires in computing system 100. For example, one or more of interfaces 130-132 sends read responses and write responses on a single bus within routing network 120.

In various implementations, communication fabric 110 (“fabric”) transfers requests, responses, and messages between the clients 140, the display controller 150, the memory controller 160, and the control circuit 170. When network messages include requests for obtaining targeted data, one or more of interfaces 112, 114, 116, 130 and 132 and network switches 122-128 translate target addresses of requested data. In various implementations, one or more of fabric 110 and routing network 120 include status and control registers and other storage elements for storing requests, responses, and control parameters. In some implementations, fabric 110 includes control logic for supporting communication, data transmission, and network protocols for routing data over one or more buses. In some implementations, fabric 110 includes control logic for supporting address formats, interface signals and synchronous/asynchronous clock domain usage.

In order to maintain full throughput, in some implementations each of the network switches 122-128 processes a number of packets per clock cycle equal to a number of read ports in the switch. In various implementations, the number of read ports in a switch is equal to the number of write ports in the switch. This number of read ports is also referred to as the radix of the network switch. When one or more of the network switches 122-128 processes a number of packets less than the radix per clock cycle, the bandwidth for routing network 120 is less than maximal. Therefore, the network switches 122-128 include storage structures and control logic for maintaining a rate of processing equal to the radix number of packets per clock cycle.

In an implementation, network switches 122-128 include separate input and output storage structures. In another implementation, network switches 122-128 include centralized storage structures, rather than separate input and output storage structures. The network switches 122-128 store payload data of the packets in a separate memory structure so the relatively large amount of data is not shifted with corresponding control and status metadata stored in another queue. The network switches 122-128 include circuitry to maintain an age of packets and generate a priority of packets. The generation of the priority of packets includes any combination of one or more parameters such as an age, a source identifier, a destination identifier, an assigned priority level, an assigned quality of service (QoS) parameter, an assigned weight value, a data size of requested data, a data size of payload data, and so on. In various implementations, one or more of network switches 122-128 include control circuitry that selects non-contiguous queue entries for deallocation in a single clock cycle based on the generated priority. In order to maintain full throughput, the number of queue entries selected for deallocation is up to the radix of the network switch (i.e., the maximum number of packets that can be received by the switch in a single clock cycle).

Interfaces 112-116 are used for transferring data, requests and acknowledgment responses between routing network 120 and the clients 140. Interfaces 130-132 are used for transferring data, requests and acknowledgment responses between the routing network 120 and the display controller 150 and the memory controller 160. Similar to the network switches 122-128, interfaces 112-116 and 130-132 are capable of including mappings between address spaces and memory channels. Similar to the network switches 122-128, the interfaces 112-116 support communication protocols with processor 140, processor 144 and I/O peripheral device 146. Similar to the network switches 122-128, interfaces 112-116 include queues for storing requests and responses, and selection circuitry for arbitrating between received requests before sending requests to a next stage of routing. Interfaces 112-116 also include logic for generating packets, decoding packets, and supporting communication with routing network 120. In some implementations, each of interfaces 112-116 communicates with a single client as shown. In other implementations, one or more of interfaces 112-116 communicate with multiple clients and track transferred data with a client using an identifier that identifies the client.

The memory subsystem 162 includes any number and type of memory controllers and memory devices. In one implementation, the memory subsystem 162 operates at various different clock frequencies which can be adjusted according to various operating conditions. However, when a memory clock frequency change is implemented, memory training is typically performed to modify various parameters, adjust the characteristics of the signals generated for the transfer of data, and so on. For example, the phase, the delay, and/or the voltage level of various memory interface signals are tested and adjusted during memory training. Various signal transmissions are conducted between the memory controller 160 and one or more memory devices in order to train these memory interface signals. During this training, memory accesses are generally halted. Finding an appropriate time to perform this memory training when modifying a memory clock frequency can be challenging.

In various implementations, the control circuit 170 includes power management circuitry. When a P-state change is to be performed, control circuit 170 causes the display controller 150 to initiate a prefetch of display data from the memory subsystem 162 in advance of the P-state change. When the P-state of the memory subsystem 162 is changed, this causes memory training to be performed which temporarily blocks accesses to the memory subsystem 162. By causing the display controller 150 to prefetch display data (via prefetch controller 152), the display controller 150 will not be deprived of video data during the training period. The prefetched data (e.g., pixel data) is stored in buffer 154 of the display controller 150 and driven to the display 156.

In one implementation, the control circuit 170 compares real-time memory bandwidth demand of the memory subsystem 162 to the available memory bandwidth provided with the current memory clock frequency of the clock signal generator 166. If the available memory bandwidth with a current memory clock frequency differs from the real-time memory bandwidth demand by more than a threshold, then control circuit 170 changes the operating clock frequencies of one or more clock signals of the memory subsystem 162.

In various implementations, the control circuit 170 determines if conditions for performing a power-performance state (also referred to as a “P-state”) have been detected. In various implementations, a change in a P-state causes a change in performance (throughput) and/or power consumption of a given device. For example, a higher performance P-state includes an increase in the operating clock frequency and the operating power supply voltage provided to a particular device. Conversely, a lower performance P-state includes a decrease in the operating clock frequency and the operating power supply voltage provided to the particular device. A P-state change of the memory subsystem 160 includes adjusting at least the clock signal generator 166 to provide a different operational clock frequency to one or more memory devices.

When conditions for performing a P-state change of the memory devices of the memory subsystem 162 memory device(s) 140 is detected, control circuit 170 determines when to implement the P-state change. Prior to implementing the P-state change, the control circuit 170 conveys one or more signals over the sideband interface 177 to the display controller 150. In one implementation, indications are transferred on the sideband interface 177 separate from the communication channel 180 used for passing pixel information to the display controller 150. In some implementations, the communication channel 180 uses a communication protocol of an embedded display port (eDP) interface, a DisplayPort (DP) interface, or a high-definition multimedia interface (HDMI). In other implementations, the communication channel 180 uses a variety of other types of communication protocols of other types of interfaces. In other implementations, the communication channel 180 is compatible with any of various other protocols. Sending the indications over the sideband interface 177 allows the timing and scheduling of prefetch operations by the prefetch controller 152 to occur in a relatively short period of time. This is in contrast to the traditional method of sending a request over the communication channel 180 and the fabric 110, which can result in a lag of several frames. In addition, the control circuit 170 conveys one or more indications the signal 176 over a sideband interface to the memory subsystem 162 that indicates that the memory subsystem 162 changes its P-state from its current value to a new value.

When the display controller 150 receives indications on the sideband channel 177, the prefetch controller 152 of the display controller 150 prefetches additional data into the buffer 154 in anticipation of an upcoming memory blackout period (i.e., the period during which memory accesses are not permitted). This step prevents interrupts in the display data that can cause visual artifacts, etc. In some implementations, the control circuit 170 also sends, via the interface 134, indications to the network switches 122-128 that specify increasing the priority of packets from the display controller 150. In other words, the indication causes an increase in the priority of packets from the display controller 150. In other implementations, the control circuit 170 sends indications on the sideband interface (or sideband channel) 178 to the control and status registers (CSRs) 136 with indications to the network switches 122-128 that specify increasing the priority of packets from the display controller 150. The network switches 122-128 either receive indications from the CSRs 136, or the network switches 122-128 access the CSRs 136 on a periodic basis. In an implementation, the CSRs 136 store updated priorities or weight values for one or more of the display controller 150 and the clients 140. In other implementations, the CSRs 136 store an indication that the prefetch controller 152 is about to begin prefetching operations, and the network switches 122-128 begin using local copies of updated priorities or weight values for one or more of the display controller 150 and the clients 140.

In an implementation, the indications from the control circuit 170 specify to the fabric 110 to increase the priority of packets from the display controller 150 such that the bandwidth of packets between the display controller 150 and the memory controller 160 at least doubles a presently used bandwidth. By doing so, the control circuit 170 reconfigures the arbitration circuitry of the network switches 122-128 of the fabric 110. In some implementations, the indications also cause the queues of the network switches 122-128 to reserve a particular allocation for packets that are sent between the display controller 150 and the memory controller 160. As such, the memory bandwidth of the display controller 150 temporarily increases (e.g., doubles or otherwise increases by a different amount). Therefore, each of the fetching circuitry and the prefetch controller 152 of the display controller 150 are able to retrieve data from the memory subsystem 162 without the memory bandwidth of either one being less than a previous memory bandwidth of the display controller 150 due to having two sources retrieving data. Accordingly, visual artifacts due to interrupts or delays in the display data arriving from the memory subsystem 162 to the display controller 150 are avoided.

In an implementation, the indications from the control circuit 170 also specify decreasing, rather than maintaining, the priority of packets from the clients 140 such that the bandwidth of packets between the display controller 150 and the memory controller 160 at least doubles a presently used bandwidth. Once prefetch controller 152 has completed prefetch of data from the memory subsystem 162, the control circuit 170 generates a command to program clock signal generator 166 to generate the memory clock at a different frequency. In addition, once the prefetch operations have completed, the control circuit 170 returns the priorities of packets from the clients 140 and the display controller 150 to their original values. While control circuit 170 is shown as a separate component from the clients 140, this is representative of one particular implementation. In another implementation, the functionality of control circuit 170 is performed, at least in part, by one or more of the clients 140.

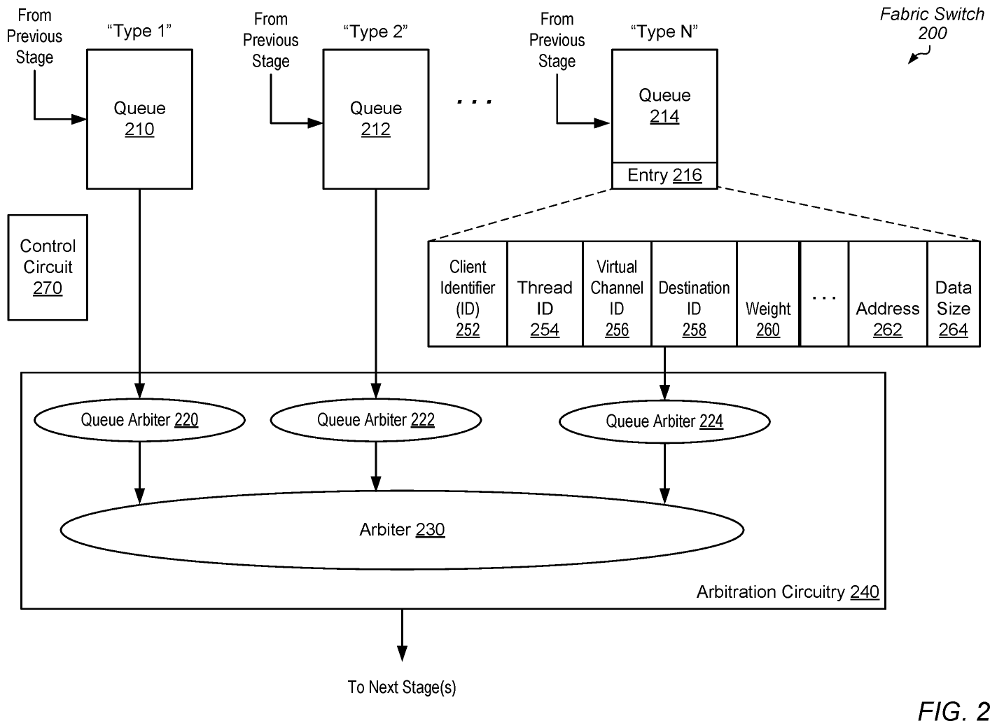

Referring to FIG. 2, a generalized block diagram is shown of an implementation of a fabric switch 200. The fabric switch 200 is a generic representation of multiple routers or switches used in a communication fabric for routing packets, responses, commands, messages, payload data, and so forth. Interface circuitry, clock signals, clock generating circuitry, configuration registers, and so forth are not shown for ease of illustration. Although fabric switch 200 is shown to handle data flow in a particular direction, in some implementations, the fabric switch 200 also includes components to support data flow in the other direction as well. In other implementations, another fabric switch handles data flow in the other direction of the communication fabric. In the illustrated implementation, the fabric switch 200 includes queues 210-214, each for storing packets of a respective type. Although the data for transmission is described as packets routed in a network, such as a router network of a communication fabric, in other implementations, the data for transmission is a bit stream or a byte stream in a point-to-point (P2P) interconnection.

In various implementations, queues 210-214 store control packets to be sent on a fabric link. Corresponding data packets, such as the larger packets are sent from another source or from other queues (not shown) within the fabric switch 200. In an implementation, the fabric switch 200 sends one or more packets on a fabric link to a next stage within the communication fabric when control circuitry of the next stage sends an indication, such as credits or other, to the fabric switch 200 specifying that there is available data storage for one or more packets.

Examples of control packet types stored in queues 210-214 include request type, response type, probe type, and a token or credit type. Other examples of packet types are also included in other implementations. As shown, queue 210 stores packets of “Type 1,” which is a control request type in an implementation. Queue 212 stores packets of “Type 2,” which are control response type in an implementation. Queue 214 stores packets of “Type N,” which are control token or credit type in an implementation. In yet other implementations, the packet types are defined by the source of the packets such as a particular processor, an I/O interface, a display controller, a memory subsystem, or other.

As shown, queue 216 includes the queue entry 216 (or entry 216) that includes multiple fields 252-264. Although particular information is shown as being stored in the fields 252-264 and in a particular contiguous order, in other implementations, a different order is used and a different number and type of information is stored. As shown, field stores a client identifier (ID), and the field 254 stores a virtual channel ID. Request streams from multiple different physical devices flow through virtualized channels (VCs) over a same physical link. Field 258 stores a destination ID, the field 260 stores a weight value, the field 262 stores a target address, and field 264 stores a data size of targeted data. Other fields included in entries 252-264, but not shown, include a status field indicating whether an entry stores information of an allocated entry. Such an indication includes a valid bit. Another field stores an indication of the packet type.

Queue arbiter 220 of the arbitration circuitry 240 selects one or more packets from queue 210. In some implementations, queue arbiter 220 selects packets in an out-of-order manner based on one or more attributes (arbitration attributes) that include one or more of an age, a priority level of the packet type (or data type), a priority level of the packet (or data), a quality-of-service (QOS) parameter, an assigned weight value, a source identifier, a destination identifier, an application identifier or type, such as a real-time application, an indication of data type, such as real-time data, a bandwidth requirement (or a bandwidth allocation), a latency tolerance requirement, a data size of requested data, a data size of payload data, and so forth. In a similar manner, queue arbiters 222-224 select packets from queues 212-214, and provide the selected packets to the arbiter 230. The arbiter 230 determines which of the received packets are transferred to the one or more next stages of the communication fabric. In some implementations, one or more of the queue arbiters 220-224 and the arbiter 230 uses a weighted sum of the attributes for selecting packets for issue. In an implementation, queue arbiters 220-224 select packets 230-234 from queues 210-214 each clock cycle.

Control circuit 270 determines which of the queue entries of the queues 210-214 are available for allocation for received packets. Control circuit 270 can change the amount of allocation for particular packets. In an implementation, when an external memory subsystem is going to perform training of its memory interface, the control circuit 270 receives an indication, such as a sideband signal (not shown), that specifies increasing the bandwidth requirement for data transferred between the memory subsystem and a display controller. In other words, the indication causes an increase in memory bandwidth, of the memory subsystem, allocated to the display controller. The external power management circuitry determines that one or more conditions are satisfied for changing a power-performance state (P-state) of the memory subsystem. Prior to the P-state change of the memory subsystem, using the increased bandwidth provided by the communication fabric, the display controller prefetches display data from a frame buffer of the memory subsystem. This prefetched display data is not immediately sent to the display device. The prefetching of this display data is performed in addition to the fetching of display data that is immediately sent to the display device.

The memory access requests and the payload data of both the fetched display data and the prefetched display data traverse through the fabric switch 200. Due to prefetching display data, the display controller requires the increased bandwidth of data transfer within the fabric switch 200 between the display controller and the memory subsystem. The display controller requires the prefetched data to later send to the display device during the training of the memory interface that occurs as a result of the upcoming P-state change of the memory subsystem. Therefore, during training of the memory interface performed in preparation for the upcoming P-state change, the display device continues to receive display data and avoids visual artifacts due to interrupts or delays in the display data arriving at a display controller from the memory subsystem.

The control circuit 270 adjusts the allocation of packets in the queues 210-214 based on a received indication. In order to increase selection by the queue arbiters 220-224 and the arbiter 230, the control circuit 270 also updates one or more attributes of packets corresponding to data transferred between the memory subsystem and a display controller. In an implementation, the control circuit 270 updates the one or more attributes in order to increase the memory bandwidth, such as double the memory bandwidth, of data transferred between the memory subsystem and a display controller.

The increased memory bandwidth for the display controller allows the display controller to prefetch display data that is not immediately sent to the display device from a frame buffer of the memory subsystem prior to the P-state change When the external memory subsystem has completed performing training of its memory interface, the control circuit 270 receives an indication (sideband signal or other) that specifies returning the memory bandwidth allocations to original values for one or more computing clients (or clients) and the display controller. Based on this received indication, the control circuit 270 adjusts the allocation of packets in the queues 210-214 and adjusts one or more attributes to return the memory bandwidths to their previous values. Therefore, when there is no P-state change for the memory subsystem, the fabric switch 200 can assign high memory bandwidth allocations to one or more clients for processing workloads. When there is a P-state change for the memory subsystem, the fabric switch 200 can adjust the memory bandwidth allocations of the one or more clients and the display controller to support prefetching of display data.

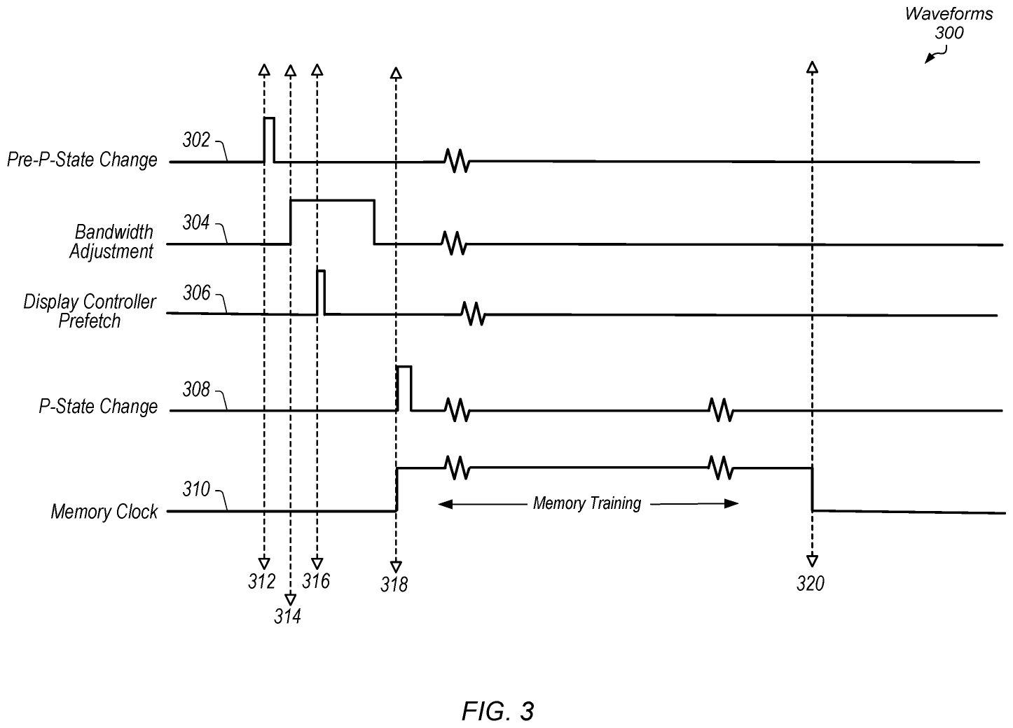

Referring now to FIG. 3, a generalized diagram is shown of a timing diagram of waveforms 300 of one implementation of the timing of a memory clock frequency update for a multi-display system is shown. In the example shown, signals are generated that enable a display controller to have temporarily increased memory bandwidth in advance of a P-state change to a memory device. As shown, FIG. 3 illustrates a pre-P-state change signal that is generated when it has been determined that a memory P-state change is to occur. Such a determination is made by a control circuit that includes power management circuitry such as control circuit 170 (of FIG. 1).

At point in time 312 (or time 312), a pre-P-state change 302 signal is indicated. It is noted that while the discussion describes various signals and indications as being “asserted” and/or “conveyed”, such assertion/conveyance takes a variety of forms depending on the implementation. For example, in some implementations, assertion of a signal is implemented by causes the signal to attain a particular value or voltage level. In other implementations, assertion of a signal or indication is performed by writing a particular value(s) to a register or memory location. All such implementations are possible and are contemplated. In response to detecting the signal 302, one or more bandwidth adjustment signals 304 are generated at a time 314. In another implementation, bandwidth reduction is asserted by the control circuit directly before initiating a pre-P-state change.

The amount of time that elapses between the assertion of signal 302 and signal 304 varies depending on the implementation. In some implementations, the indications conveyed on the sideband interface 178 (of FIG. 1) corresponds to the bandwidth adjustment signal 304. In various implementations, bandwidth adjustment circuitry corresponding to a circuit, such as circuitry of the network switches 122-128 and the CSRs 136 (of FIG. 1) and the control circuit 270 (of FIG. 2), detect the bandwidth adjustment signal 304, and perform steps to increase the bandwidth (or rate) of the transfer of data between the memory subsystem and a display controller. These steps can also include steps to reduce the bandwidth (or rate) of data transfer between the memory subsystem and one or more clients different from the display controller. As described earlier, examples of the clients are a variety of types of processors, one or more of a variety of input/output (I/O) peripheral devices, and so forth. The duration of the bandwidth adjustment in a communication fabric varies depending on the implementation. In some implementations, the duration is for a fixed amount of time that is programmable. In other implementations, the duration lasts for a period of time that is determined based on a further signal or other indication specifying that the prefetch operations of a display controller have been completed. Various such implementations are possible and are contemplated.

Subsequent to assertion of the bandwidth adjustment signal 304, a prefetch signal 306 is conveyed by the control circuit (e.g., control circuit 170 of FIG. 1) to the display controller at time 316. In some implementations, the prefetch signal 306 is conveyed simultaneously with assertion of the bandwidth adjustment signal 304. In other implementations, there is a delay between assertion of signal 304 and signal 306. Responsive to assertion of the prefetch signal 306, the display controller initiates a prefetch of data from a memory subsystem. As discussed earlier, during the prefetch of data from memory, other memory access generating clients have their memory bandwidth temporarily reduced to ensure the display controller has a desired increase in bandwidth. In this manner, a desired quality of service (QOS) of the data being displayed is maintained.

After the display controller completes its access of memory, the bandwidth adjustment signal 304 is de-asserted (or negated) and the control circuit then causes a P-state change for the memory. In the example shown, the controller asserts a P-state change signal 308 at time 318. In various implementations, the control circuit also conveys or stores an indication as to the new P-state, and clock frequency, to which the memory is to transition. The memory clock 310 is updated based on the new operating clock frequency. For example, clock generating circuitry uses the new operating clock frequency to generate the memory clock 310. Responsive to the P-state change signal 308 at time 318, the memory subsystem enters the above discussed training period. As noted, many memory devices (e.g., graphics double data rate (GDDR) synchronous dynamic random-access memory (SDRAM) devices) require memory training when a memory clock frequency is changed. For these memory devices, memory training is performed as part of the memory clock frequency change. After a period of time, the memory training is completed at a time 320 and the memory (subsystem) achieves a stable state at the new P-state. At this time, accesses to the memory are no longer blocked (i.e., the memory blackout period ends).

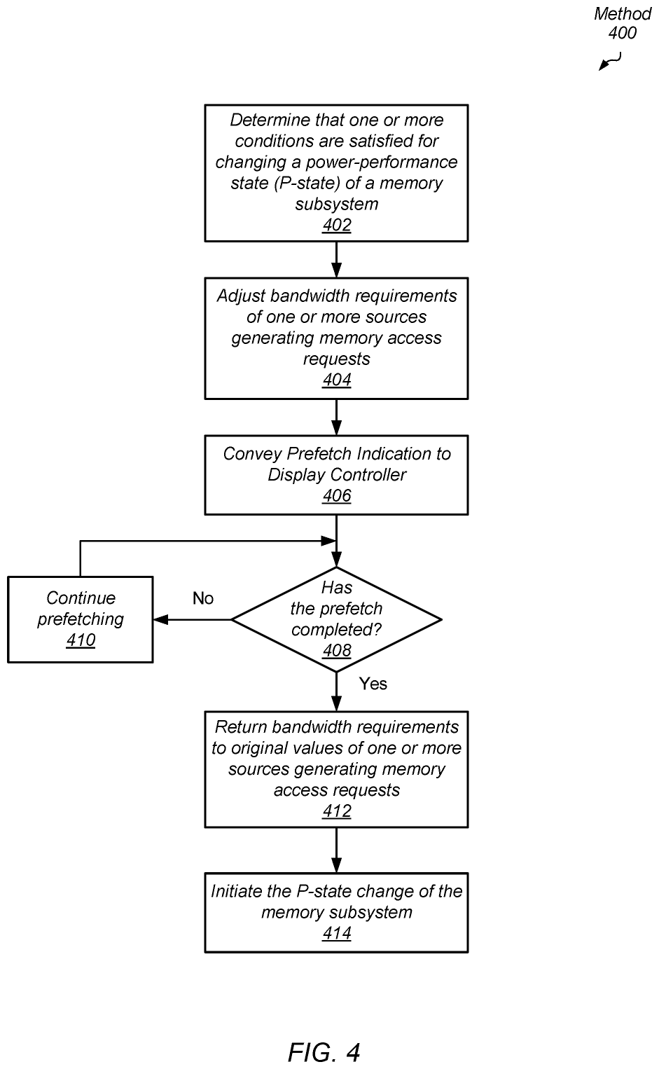

Referring now to FIG. 4, one implementation of a method 400 for performing a display controller prefetch in advance of memory clock frequency changes is shown. For purposes of discussion, the steps in this implementation are shown in sequential order. However, it is noted that in various implementations of the described methods, one or more of the elements described are performed concurrently, in a different order than shown, or are omitted entirely. Other additional elements are also performed as desired. Any of the various systems or apparatuses described herein are configured to implement method 400.

In various implementations, a computing system includes multiple computing clients (or clients) and a display controller that generate memory access requests targeting data stored in a memory subsystem. Examples of the clients are a central processing unit (CPU), an application specific integrated circuit (ASIC), a field programmable gate array (FPGA), a processor with a highly parallel microarchitecture such as a graphics processing unit (GPU) or a digital signa processor (DSP), one of a variety of input/output (I/O) peripheral devices, and so forth. The computing system also includes a communication fabric that transfers data between the multiple clients, the display controller, and the memory subsystem. A control circuit with power management circuitry determines that one or more conditions are satisfied for changing a power-performance state (P-state) of the memory subsystem (block 402).

In an implementation, the control circuit has detected an increase or decrease in required memory bandwidth based on tasks being executed (or tasks queued for execution), thermal conditions, or otherwise. For example, the condition is triggered in response to tasks corresponding to a particular type of application having an increased memory bandwidth requirement. In response, an increase in the P-state of the memory is indicated. If the control circuit detects an increase in memory accesses, then the control circuit can increase the operational clock frequency of one or more memory devices of the memory subsystem in order to increase the rate at which memory accesses can be completed. Conversely, if the control circuit detects a decrease in memory accesses, then the control circuit can decrease the operational clock frequency of one or more memory devices of the memory subsystem in order to reduce power consumption.

As another example, one or more processing circuits in the computing system are detected to be in an idle condition or otherwise have a reduced memory bandwidth requirement. In response, a reduction in a P-state of the memory is initiated to reduce power consumption of the system. Other conditions can cause a memory clock frequency change in other implementations. For example, in one implementation, connecting or disconnecting alternating current (AC) power or direct current (DC) power can cause a memory clock frequency change. There are different allowable clock ranges depending on the power source. In another implementation, a change in the temperature of the host system or apparatus can trigger a desired to change the memory clock frequency. For example, if the temperature of the host system/apparatus exceeds a first threshold, then the control circuit will attempt to reduce power consumption in order to lower the temperature. One of the ways for reducing the power consumption is by decreasing the memory operating clock frequency.

In a further implementation, if the temperature falls below a second threshold, the control circuit can increase the memory operating clock frequency since doing so will not cause the system/apparatus to overheat. In a still further implementation, if there is a requested performance increase, or a performance increase is otherwise deemed to be desirable (e.g., to increase computation speed, frame rate of a video display, or otherwise), then the control circuit will attempt to increase performance by increasing the memory clock frequency. Other conditions for changing the memory clock frequency are possible and are contemplated.

The control circuit adjusts the bandwidth allocations of one or more sources generating memory access requests (block 404). The sources include the multiple clients and the display controller. In some implementations, the control circuit asserts one or more indications on a sideband interface specifying to a communication fabric that the display controller is to have an increased bandwidth (or rate) of data transfer between the display controller and the memory subsystem. In other words, the indication causes an increase in memory bandwidth, of the memory subsystem, allocated to the display controller. In other implementations, the control circuit sends these indications to an interface of the communication fabric used for other types of messages as well, rather than on a dedicated sideband interface.

In an implementation, the control circuit also includes in the indications on the sideband interface (or other interface) one or more of a weight value, a bandwidth or rate requirement, or other data used by the communication fabric to adjust the memory bandwidth of the display controller. These indications can specify increasing this memory bandwidth of the display controller to at least double the presently used memory bandwidth. It is also possible and contemplated that the control circuit sends indications to the communication fabric specifying that the clients are to have a decreased bandwidth (or rate) of data transfer between the clients and the memory subsystem. Based on the received indications, the circuitry of the communication fabric adjusts the allocation in queues of memory access requests from the clients and the display controller during data transport within the communication fabric. The allocation adjustments increase the bandwidth (or rate) of data transfer between the display controller and the memory subsystem. The circuitry of the communication fabric also updates one or more attributes used by arbitration circuitry that selects data from queue entries during data transport in the communication fabric. The attributes adjustments increase the bandwidth (or rate) of data transfer between the display controller and the memory subsystem.

In some implementations, the condition for triggering a change to the memory clock frequency can be event driven. For example, in various implementations, the memory controller posts events related to throughput when the throughput goes over or under some threshold. Such events can be monitored during programmable windows of time or otherwise filtered temporally in some way. It is also possible that the control circuit predicts that a particular workload will require resources before the workload is scheduled or executed. Similarly, when the workload finishes, the control circuit predicts which resources are no longer required (i.e., the workload in question has completed and no longer requires a particular resource). Also, the control circuit can account for periodic workloads. In another implementation, a real-time operating system (RTOS) is aware of deadlines, and the RTOS is able to select more optimal operating clock frequencies depending on an approaching deadline.

The control circuit generates, or otherwise conveys, a prefetch indication to the display controller (block 406). Prior to the P-state change of the memory subsystem, using the increased bandwidth provided by the communication fabric, the display controller prefetches display data from a frame buffer of the memory subsystem. This prefetched display data is not immediately sent to the display device. The prefetching of this display data is performed in addition to the fetching of display data that is immediately sent to the display device. The display controller requires the prefetched data to later send to the display device during the training of the memory interface that occurs as a result of the upcoming P-state change of the memory subsystem. Therefore, during training of the memory interface performed in preparation for the upcoming P-state change, the display device continues to receive display data and avoids visual artifacts due to interrupts or delays in the display data arriving at a display controller from the memory subsystem.

In response to detection of the prefetch signal, the display controller initiates prefetch of display data from the memory subsystem. If the prefetch operations have not yet completed (“no” branch of the conditional block 408), then a prefetch controller or other circuitry of the display controller continues to prefetch display data from the memory subsystem (block 410). If the prefetch operations have completed (“yes” branch of the conditional block 408), then the control circuit returns bandwidth allocations to original values of one or more sources generating memory access requests (block 412). The sources include the multiple clients and the display controller. In various implementations, the control circuit uses the indications described earlier for providing information to the communication fabric on how to adjust the bandwidth allocations.

Subsequent to completion of the prefetch of data by the display controller, the control circuit waits for training of the memory interface of the memory subsystem to complete. Upon completion of the training, the control circuit initiates the P-state change of the memory subsystem (block 414). In various implementations, completion of the prefetch is determined based on the elapse of a given period of time (which can be programmable). In other implementations, the display controller conveys an indication that the prefetch has completed. In such an implementation, the display controller conveys the indication in response to receiving the prefetch data or otherwise determining the prefetch of the data from the memory is complete and is in transit to the display controller. In other words, further accesses to the memory are not believed to be required even though all of the prefetched data has not yet reached the display controller. In various implementation, the P-state change includes changing one or more of the operating clock frequency and the operating power supply voltage level of one or more memory devices of the memory subsystem. Therefore, using the above steps, when there is no P-state change for the memory subsystem, the control circuit can assign high memory bandwidth allocations to one or more clients for processing workloads. When there is a P-state change for the memory subsystem, the control circuit can adjust the memory bandwidth allocations of the one or more clients and the display controller to support prefetching of display data.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a control circuit, wherein responsive to a condition being satisfied for changing one or more operating parameters of a memory subsystem, the control circuit is configured to:
send a first indication to a communication fabric that causes an increase in memory bandwidth, of the memory subsystem, allocated to a display controller; and
send a second indication to the display controller which causes the display controller to prefetch display data from the memory subsystem.

2. The apparatus as recited in claim 1, wherein the second indication causes a change to one or more arbitration attributes associated with memory requests generated by one or more computing clients.

3. The apparatus as recited in claim 2, wherein the arbitration attributes include a priority level.

4. The apparatus as recited in claim 1, wherein the control circuit is further configured to send a third indication that causes a decrease in memory bandwidth allocated to the display controller.

5. The apparatus as recited in claim 4, wherein the control circuit is configured to convey the third indication responsive to the display controller completing the prefetch.

6. The apparatus as recited in claim 5, wherein the control circuit is further configured to initiate training of a memory interface of the memory subsystem subsequent to the prefetch.

7. The apparatus as recited in claim 1, wherein the one or more operating parameters include a power state change of the memory subsystem.

8. A method comprising:
transferring data, by a communication fabric, between at least a plurality of clients, each comprising circuitry configured to execute applications; and
responsive to a condition is satisfied for changing one or more operating parameters of a memory subsystem:
sending, by a control circuit, a first indication to the communication fabric that causes an increase in memory bandwidth, of the memory subsystem, allocated to a display controller; and
sending, by the control circuit, a second indication to the display controller which causes the display controller to prefetch display data from the memory subsystem.

9. The method as recited in claim 8, further comprising causing, by the control circuit, a change to one or more arbitration attributes associated with memory requests generated by one or more clients of the plurality of clients.

10. The method as recited in claim 9, wherein the arbitration attributes include a size of the data.

11. The method as recited in claim 8, further comprising sending, by the control circuit, a third indication that causes a decrease in memory bandwidth allocated to the display controller.

12. The method as recited in claim 11, further comprising conveying, by the control circuit, the third indication responsive to the display controller completing the prefetch.

13. The method as recited in claim 12, further comprising initiating, by the control circuit, training of a memory interface of the memory subsystem subsequent to the prefetch.

14. The method as recited in claim 8, wherein the condition comprises a change in a number of memory accesses generated by one or more clients exceeds a threshold.

15. A computing system comprising:
a communication fabric configured to transfer data between at least a plurality of clients, each comprising circuitry configured to execute applications; and
a control circuit comprising circuitry, wherein responsive to a condition being satisfied for changing one or more operating parameters of a memory subsystem, the control circuit is configured to:
send a first indication to the communication fabric that causes an increase in memory bandwidth, of the memory subsystem, allocated to a display controller; and
send a second indication to the display controller which causes the display controller to prefetch display data from the memory subsystem.

16. The computing system as recited in claim 15, wherein the second indication causes a change to one or more arbitration attributes associated with memory requests generated by one or more clients of the plurality of clients.

17. The computing system as recited in claim 16, wherein the arbitration attributes include a source identifier of the data.

18. The computing system as recited in claim 15, wherein the control circuit is further configured to send a third indication that causes a decrease in memory bandwidth allocated to the display controller.

19. The computing system as recited in claim 18, wherein the control circuit is configured to convey the third indication responsive to the display controller completing the prefetch.

20. The computing system as recited in claim 19, wherein the control circuit is further configured to initiate training of a memory interface of the memory subsystem subsequent to the prefetch.
